(19) United States
(12) Patent Application Publication
(10) Pub. No.: US 2025/0232687 A1
(43) Pub. Date: Jul. 17, 2025

(54) SYSTEMS AND METHODS FOR MATH EDUCATION

(71) Applicant: Abacomps, INC, Rockville, MD (US)

(72) Inventor: Jae Sic CHOI, Rockville, MD (US)

(73) Assignee: Abacomps, INC, Rockville, MD (US)

(21) Appl. No.: 19/096,909

(22) Filed: Apr. 1, 2025

Related U.S. Application Data
(63) Continuation-in-part of application No. 18/350,942, filed on Jul. 12, 2023.

(51) Int. Cl. G09B 7/02

(52) U.S. Cl. CPC G09B 7/02

(57) ABSTRACT

Systems and methods for teaching mathematics may be provided. In some embodiments the system may be used in conjunction with an abacus in order to increase the student's understanding of math and teach how to use an abacus. A math network may utilize one or more databases and/or one or more modules in order to customize the curriculum for a student.

### BACKGROUND

The abacus math learning method is an ancient system of arithmetic calculation that uses a physical counting device known as an abacus. The abacus consists of a series of rods or wires, each containing a set of beads that can be manipulated by sliding them back and forth. The method is rooted in the concept of place value, where the position of a digit determines its value within a number. Each rod on the abacus represents a different place value, such as units, tens, hundreds, and so on. The beads on each rod represent specific numerical values, such as 1, 5, or 10.

To perform calculations using the abacus, the user moves the beads on the rods according to the arithmetic operations they want to perform. For example, to add two numbers, the corresponding beads on each rod are moved and the total number of beads in each column are counted to determine the final result. The abacus math learning method has several advantages. It helps develop strong mental calculation skills, improves concentration and focus, enhances hand-eye coordination, and provides a tangible representation of mathematical concepts.

Math education, however, is generally set and the same for a given population of students, e.g. students in the same grade or of a certain age. Therefore, all students are subject to the same pacing and learning style, which may leave some students behind or stifle the growth of other students. A math network may utilize one or more databases, such as a student information database and student history database and/or one or more modules such as a problems module and a customization module in order to customize the curriculum for a student.

### SUMMARY

In one or more exemplary embodiment a systems and methods for teaching mathematics may be provided. In some embodiments the system may be used in conjunction with an abacus in order to increase the student's understanding of math and teach how to use an abacus.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 illustrates a math education system, according to an embodiment.

FIG. 2 illustrates an exemplary game GUI.

FIG. 3 is an exemplary illustration of a base module.

FIG. 4 is an exemplary illustration of a problems module.

FIG. 5 is an exemplary illustration of a customization module.

FIG. 6a is an exemplary illustration of an AI solution assistant module.

FIG. 6b is an exemplary illustration of an AI helper assistant module.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, a computer configured to perform the described action.

Many of the embodiments described herein are described in terms of sequences of actions to be performed by, for example, an Artificial Intelligence (AI) module or modules. It will be understood by those skilled in the art that the sequence of actions described herein can be embodied entirely within any form of AI or ML architecture such that execution of the sequence of actions enables the processor to perform the functionality described herein. Thus, the various aspects of the present invention may be embodied in a number of different forms, all of which have been contemplated to be within the scope of the claimed subject matter. For example, machine learning architectures include but are not limited to Artificial Neural Networks (ANNs), Multi-Layer-Perceptrons (MLPs), Support Vector Machines (SVMs), Recurrent Neural Networks (RNNs), Convolutional Neural Networks (CNNs), Large Language Models (LLMs), transformers, decision trees, random forests, expert systems, mixture of experts models, ensemble models, diffusion models, and autoencoder models, to name a few. However, many other forms of AI and ML architectures that enable the processor to perform the same functionality have been considered.

It may generally be contemplated for any AI or machine learning architecture to be retrained according to the data processed herein, for example automatically or continuously retrained on a predetermined schedule or based on one or more triggers, such as based on one or more detected changes in the data.

It may be contemplated for execution of the sequence of actions contemplated to be undertaken by the AI or ML architecture to be based on data retrieved from any sensor contemplated herein, and for execution of the sequence of actions to include actuation of any of the one or more transducers contemplated herein.

In one or more exemplary embodiment systems and methods for teaching mathematics may be provided. In some embodiments the system may be used in conjunction with an abacus in order to increase the student's understanding of math and teach how to use an abacus.

It can be noted that as used herein and in the appended claims, the singular forms “a,” “an,” and “the” include plural references unless the context clearly dictates otherwise. Although any systems and methods similar or equivalent to those described herein can be used in the practice or testing of embodiments, only some exemplary systems and methods are now described.

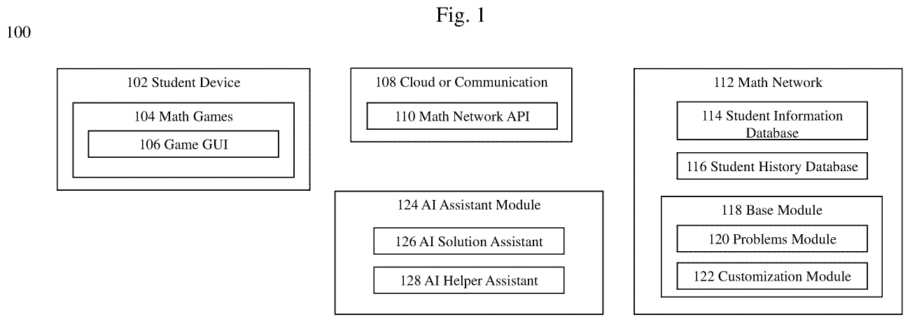

FIG. 1 is an exemplary system for mathematical education 100. The math education system 100 may include a student device 102, which may be tied to a particular student, and may be, for example but not limited to, a tablet, a personal computer, a smartphone, etc. The student device 102 may be tied to a specific student and may transmit information on that student to a student information database 114. The student device 102 may be connected to and/or able to access one or more math games 104. The math games 104 may involve a plurality of different math concepts, including addition, subtraction, multiplication, division, etc. In some embodiments the math games 104 may include a virtual abacus. The virtual abacus may be implemented in a plurality of embodiments. For example, in a first exemplary embodiment the answer to the problem may be entered using the abacus. In another exemplary embodiment the abacus may show a number on an abacus, and the correct answer may be obtained by reading the abacus and inputting the number in roman numerals. In yet another exemplary embodiment an abacus may be used in order to make a number that fills in a missing number in an equation.

In some embodiments there may be a plurality of different math games. Some exemplary math games will now be described. It may be understood that these are exemplary games and in other embodiments different combinations of games and/or additional games may be utilized.

A first exemplary math game may be math game A. In an embodiment math game A may be comprised of a plurality of individual problem sets or types. For example, a first problem set in game A may be a beginner game set. Once the beginner game set is completed math game A may then move onto the next game set. Game sets may include, for example, game sets where the student reads an abacus, game sets where the student provides a number that completes a given math problem (e.g. 1+x=7), and/or a pretest problem set to assist in determining a new students skill level. In some embodiments some or all of the game sets may have a help button, which may provide a video or text reference that explains how the given problem set works.

In an exemplary embodiment there may be additional math games, for example math game B and math game C. Each of the additional math games may present additional problem sets to the student. In some embodiments specific problem sets may be specific to specific games, for example math game B may contain addition and/or subtraction problem sets while math game C may contain multiplication and division problem sets. In some embodiments a help menu that provides a video or text reference on either the problems, type of problems, or the game itself may be presented. For example, in an embodiment the help button for games B and C may be in the form of a PDF document comprising example problems and step-by-step instructions for problem-solving. The help menu may only be shown in some versions of the problem set, for example the help menu may not be available for students above a certain level.

Another exemplary math game may be math game D, which may be a plurality of individual games which operate separate from games A-C, that is they may, for example, not be bound by the restriction of advancing only one skill level higher than the other games. A first game D section may be a flash and/or call out game. In an exemplary game D callout game a series of numbers may be called out, and/or a series of numbers may be “flashed” (or briefly shown) on the screen and the student may input an answer to the numbers. The game may specify the appropriate operations (addition, subtraction, multiplication, etc.) or may just call out numbers, using positive numbers for addition and negative numbers for subtraction. The student may then input a final answer after all the numbers have been called out.

Another exemplary game D game may be a “make numbers” game, in which students are given a final answer and must input a series of numbers, for example 3-5 single digit numbers, in order to make a set that adds up to the final answer. For example, a student may be given 4 blank spaces and a final answer of 17, to get the problem correct the student may then enter 4 numbers that add up to 17, for example 9, 1, 4, and 3. In some embodiments both subtraction and addition may be included in the make numbers game, and the student may be given a single attempt for each question. Furthermore, in some embodiments, the make numbers game may have a plurality of difficulty levels corresponding to a student's skill level or belt level. For example a student of a first skill level or “white” belt level may have a make numbers question with two blank spaces, a student with a higher skill level or a “1st Dan black” level may have a make numbers game with blanks for 7 five digit numbers. In some embodiments the problems presented in the make numbers game may correspond to problems presented in game B, that is the question may correspond to an equivalent game b question except that the numbers to the left of the equal sign are blank and the answer is given, but when all blanks are filled the problem would be identical.

The virtual abacus may allow users to move the beads up and down as they please, simulating the physical use of an actual abacus. In some embodiments the virtual abacus may be togglable. That is, the virtual abacus may be shown on a GUI when toggled on, and hidden when toggled off. It may be understood that in games that specifically require the abacus, e.g. abacus reading or abacus make numbers the abacus may be always on by default.

The math games may select one or more questions for the student, based on the game selected and/or other student information or student history. The student device 102 may further include a game graphical user interface (GUI) 106 which may display the math games 104 to the student and enable the student to input answers or otherwise interact with the math games 104, for example enable the student to interact with the virtual abacus.

In some embodiments the math education system 100 may include a cloud or communication 108, which may be a wired and/or wireless network. The communication network 108, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, and other communication techniques, as desired. A math network API 110 may transmit information between the student device 102 and a math education network 112.

The math education network 112 may be a software module that analyzes student information and determines a math education curriculum for students. In some embodiments the math education network 112 may utilize artificial intelligence (AI) and/or machine learning (ML). The math education network 112 may be located on a server, and may perform real time analysis to determine student curriculum. The math network 112 may contain one or more databases, for example a student information database 114 and a student history database 116. In some embodiments the student history database may be maintained and updated by a third party. For example, in an exemplary embodiment a plurality of schools may access the math education network 112, each of the plurality of schools may keep separate student history databases that tracks individual student information of students at that school. In other embodiments there may be a centralized database that tracks a plurality of students, even through the plurality of schools or other third parties. In a centralized embodiment each third party may access and review the user's student history, for example their scores on various games, and each third party may have authority to change or designate aspects of the student history.

The student information database 114 may contain student information on one or more students, for example the students age, skill level, past game or test results, etc. In an embodiment the student information may contain, for example, a determined skill level, which may be indicated by a number or symbol, or by a belt level system. For example, the first skill level may be a white belt, the next a high white level, the next a yellow, and so on with the final level being, for example black belt, 3^{rd} dan black, or master degree. In an exemplary embodiment, a belt skill system may include, for example, white, high white, yellow, high yellow, green, high green, blue, high blue, red, high red, bo black, 1^{st} dan black, 2^{nd} dan black, 3^{rd} dan black, and master. It may be understood that not all these levels or additional levels may be used. In some embodiments certain types of problems may be introduced at specific levels, for example subtraction may be introduced at high yellow, multiplication at green, division at blue, etc. In some embodiments lower skill levels may focus on abacus math while higher skill levels may introduce mental math.

In some embodiments the student information database may organize students into “league tiers”, based on the student information. For example, a student's designation to a particular tier may be based on the student's belt skill level. In an embodiment students may compete against other students in the same or similar league tier. Competition may include, for example, answering questions within a specified time limit, and may be scored based on a plurality of factors, such as accuracy, time to completion, and/or number of questions answered. In some embodiments there may be one or more league tier leaderboards, which may display students' scores or positions within their respective league.

The league questions may, in some exemplary embodiments, emulate some or all of the games described above. Modifications to the games may be made for the league format, for example whether the answer was correct or incorrect may not be indicated until after the complete problem set is done. In some embodiments students may manually input their personal information, such as name and country. In other embodiments the results may automatically be associated with the student or certain aspects of the student, for example based off the students location, a student or school account, and/or information contained in the student information database. The league format may display one or more of subject, difficulty level, student country, student name, student score, and/or student time. In some embodiments the leaderboard may be periodically reset, for example every semester or every month.

The skill levels may correspond to the difficulty of problems provided to the student, for example in an exemplary embodiment white belt may correspond to problems containing 2 one-digit numbers, high white corresponds to problems containing 3 1-digit numbers, yellow corresponds to problems containing 4 1-digit numbers, etc. Some levels may also increase the number of digits per number, for example a high green level may contain 6 numbers up to one of which may be a 2-digit number. Different forms of math may also correspond to certain skill levels, e.g. subtraction may be introduced at the green level, multiplication at the high green level, and division at the blue level.

In some embodiments a student may have multiple skill levels, for example a belt level corresponding to mental math, and a belt level corresponding to math utilizing an abacus. In some embodiments the skill level may be further split, for example a separate skill level for abacus addition/subtraction and for abacus multiplication/division. In some embodiments the skill levels of multiple types may be tied together, for there may be a restriction in increasing one skill level over the other for related types, such the higher skill level of abacus addition/subtraction and abacus multiplication/division can only be one level higher than the lower skill level, e.g. if the student has a high blue level in abacus addition/subtraction their abacus multiplication/division math level may be blue, high blue, or red, but could not be high red until the abacus addition/subtraction level is increased. In other embodiments the band may be, instead, a larger number, for example 2 skill levels or 3 skill levels.

The student history database 116 may store all the historical student information related to various math curriculum elements. For example, the different skill levels of students of a certain age, and how those students performed on various math games or tests. The student history database 116 may further contain a plurality of problems associated with the historical student information, and furthermore may contain how populations of students performed on each of those problems, or how performance changed based on the problems provided. For example, students of a given age and skill level may tend to perform well with problem set A, but not with problem set B. The problems may further be sorted based on the problem characteristics, for example the number of digits of each number, the number of numbers in the problem, the operations used or the order of operations if multiple are used in the same problem, etc.

The math education system 100 may further include a base module 118. The base module 118 may receive information from one or more databases and/or the student device 102. The information received from the student may be information about the student tied to the student device 102 and/or may be situational information, for example about one or more ongoing math games 104. The base module 118 may store data received from the student device 102 in the one or more databases. The base module 118 may send information from the one or more databases and situational data from the student device 102 to one or more modules, and may initiate those modules, for example a problem module 120 and a customization module 122. The problem module 120 may receive student history data, student information, and/or situational data, and may generate one or more mathematical problems for the student. The customization module 122 may receive student history data, student information, and/or situational data, and may customize one or more aspects of the student math curriculum, for example difficulty level of problems, customizable GUI aspects, etc. In some embodiments the one or more modules may make adjustments in real time.

The math education system 100 may further include an AI Assistant Module 124. In some embodiments, the AI Assistant Module may include an AI Solution Assistant 126 and/or an AI Helper Assistant 128. The AI Assistant Module 124 may receive information from one or more databases and/or the student device 102. For example, in some embodiments the AI Assistant Module 124 may receive problem data and/or system instructions from the Math Network 112. In some embodiments the AI Assistant Module 124 may also receive at least one question and/or situation information from the student device 102. The AI Assistant Module 124 may send data to other parts of the math network 112.

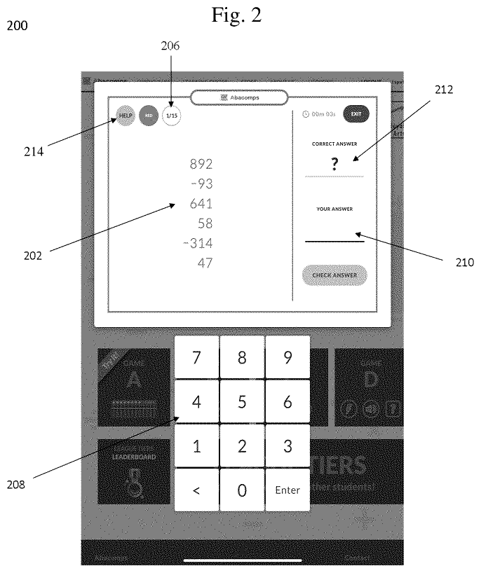

FIG. 2 illustrates an exemplary game GUI 200. The game GUI 200 may include a problem display area 202, which may display mathematical problems, for example a series of numbers that need to be added, subtracted, divided, and/or multiplied. It may be understood that in some embodiments the problems displayed in the problem display area 202 may be provided by the problem module 120. The display area 202 may also display an indication that a problem is correct or incorrect, for example a smiley face for a correct problem. The game GUI 200 may include one or more indicators, for example a difficulty indicator 204 and/or a question number indicator 206. The game GUI 200 may have a player input area 208, which may be, for example, a number pad or keyboard. In some embodiments the player input area 208 may include, instead of or in addition to a number pad, keyboard, and/or virtual abacus. In some number pad embodiments a decimal point input may also be included. It may be understood that in some embodiments where the game is accessed via a computer or other device with an external keyboard, the player input area 208 may not be shown.

The game GUI 200 may display the users input in a user input area 210, and may further have a results area 212 that displays a result based on the student's input. The result may be, for example, an indication that the answer is correct or incorrect, such as an X mark for incorrect and a check for a correct answer. In some embodiments another symbol, such as a question mark, may indicate an incorrect answer, and the color of the question mark may change as additional incorrect answers are entered, or based on how far off the incorrect answer is. In some embodiments aspects of the game GUI 200 may be modified by the customization module 122. For example, the difficulty indicator or the color of the question mark in the results area 212 may be determined by information provided by the one or more databases. For example, in an embodiment a first incorrect answer may result in an orange question mark, while a second incorrect answer may result in a text that says wrong, an X, or some other indication. In some embodiments when multiple incorrect answers are given a separate indicator, for example an emoji with X's may be shown in the display area 202 instead. The GUI 200 may further include a help button 214.

Other customizations may include, for example, utilizing an image deemed pleasant for the student, such as a smiley face, to indicate a correct answer, or when an incorrect answer is inputted by the student the correct numbers may be highlighted our otherwise have their color changed on the virtual number pad. In other embodiments the number of questions given may vary based on a combination of the type of game, and the student information.

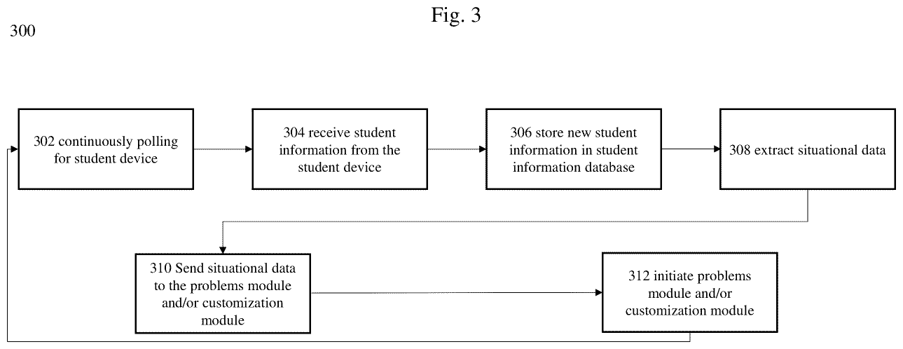

FIG. 3 provides an exemplary illustration of the base module 300. In a first step 302 the base module 118 may continuously poll the student device 102 for activity. In a next step 304 the base module 118 may receive student information from the student device 102, for example the student using the device, the age of the student, the skill level of the student, past game or exam performances for the student, etc. In a next step 306, any new student information may be stored in the student information database 114, which may contain, for example, a plurality of students and the student information related to each of those students. In a next step 308 the base module 118 may extract situational data from the student device 102. Situational data may include, for example, the game selected, how many questions have been answered, whether the answers were correct or incorrect, how many attempts were made on each question, the name or other identifier for the student, etc. In a next step 310 the base module 118 may send the situational data to the problems module 120 and/or customization module 122. In a last step 312 the base module 118 may initiate the problems module 120 and/or customization module 122.

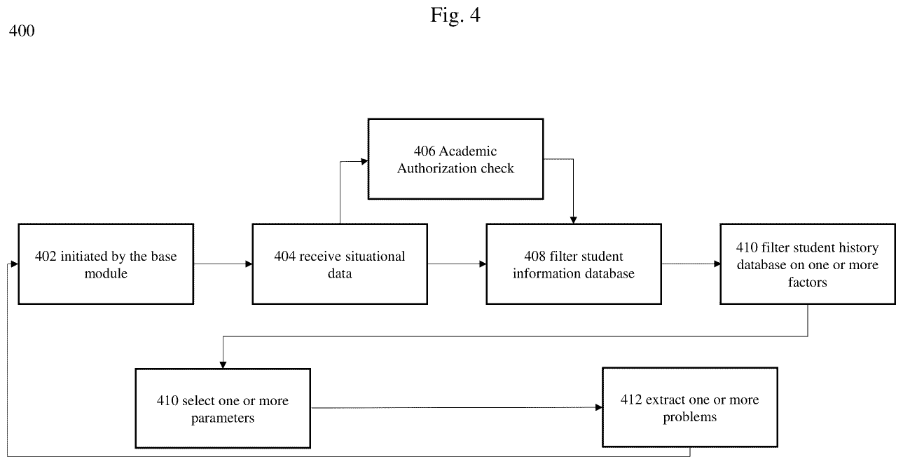

FIG. 4 provides an exemplary illustration of the problems module 400. In a first step the problems module 120 may be initiated by the base module 118. In a next step 404 the problems module 120 may receive situational data from the base module 118. In some embodiments where the student history database is kept by third parties rather than being centralized, in a step 406 the system may perform an academic authorization check with the third part in order to access relevant student information. In a next step 408 the problems module 120 may filter the student information database 114 based on a student identifier obtained from the situational data. In a next step 410 the problems module 120 may filter the student history database based on one or more factors taken from the student information database and/or situational data, e.g. the student history database 116 may be filtered based on the students age, geographic location, skill level, and previous performance within the current problem set. In a next step 412 one or more parameters may be selected, and one or more problems may be extracted in final step 414.

In an exemplary embodiment the one or more parameters may include, for example, increase in student's success rate over time, or decrease in student's average time to answer questions over time.

In an exemplary embodiment, the problems module 400 may generate each question one at a time or may generate a set of problems all at once. The problems module 400 may consider the previous or future questions in a problem set when generating questions. For example, based on information from the student information database 114 and the student history database 116, The problems module may determine an order of math problems, for example for white belt students it may be determined that having problems with answers of a single digit spaced out among the problem set (e.g. every 3rd problem) is beneficial to student's learning. Likewise, the ratio of problems with a two digit versus one digit answer may be determined. In other embodiments the same determinations may be made for more advanced problem sets, e.g. where more numbers are used or where the number of digits per number is increased. More advanced problem sets may correspond to the students calculated skill level.

The problems module 400 may further update a students skill level based on the student performance of one or more problem sets. For example the student may be raised to a higher skill level if they succeed in a certain percentage of problems in one or more problem sets. In some embodiments other factors may be considered, for example the time taken or other student information.

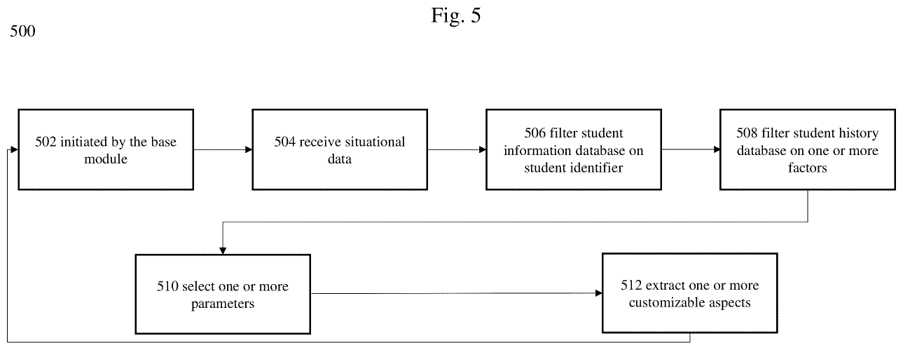

FIG. 5 provides an exemplary illustration of the customization module 500. In a first step the customization module 122 may be initiated by the base module 118. In a next step 504 the customization module 122 may receive situational data from the base module 118. In a next step 506 the customization module 122 may filter the student information database 114 based on a student identifier obtained from the situational data. In a next step 508 the customization module 122 may filter the student history database 116 based on one or more factors taken from the student information database and/or situational data, e.g. the student history database may be filtered based on the students age, geographic location, skill level, and previous performance within the current problem set. In a next step 510 one or more parameters may be selected, and one or more customizations may be extracted in final step 512, and applied to the student device 102.

For example, in an embodiment the student history database 116 may show that a certain color scheme correlates with better performance for students of a certain age, the color scheme may then be extracted and may be applied to the student device 102 and/or game GUI 106. Younger students may also perform better when instead of being given an X or other harsh indication for an incorrect answer, the color of a “?” changes each time an incorrect response is input.

In another example the end game screen of the games may be customized based on information from the student history database, the type of game, and/or how well the student performs on the game. For example, for an exemplary student game B and C may provide an end screen with a “Perfect!” visual for 15/15 questions correct, a “Congratulations!” for 12/15 questions correct, an “Almost There!” for 8/15 questions correct, and a “Good Effort!” for 0/15 questions correct. In different embodiments the thresholds or exact words used may differ. In some embodiments a different set of thresholds may be used for games being used for pretest or testing purposes, for example they may instead use pass, close to pass, and below pass scores. In an exemplary embodiment students may advance to the next level if they meet progression requirements, which may be, for example, achieving a score of 15/15. In some embodiments other aspects of the end screen, for example color of the text or background visuals such as stars may be further customized by the system. The end screen may further display other information, including but not limited to, time allowed, minimum score for passing (if a test or pretest), time taken, etc. It may be understood that different colors may provide different benefits depending on the student, for example in an embodiment orange may be used for a perfect score, and may serve as positive reinforcement and a boost to student's confidence. Blue may be used for good scores, and may acknowledge the student's progress and effort. Green may be used for scores that are almost passing but not passing, and may signal the student is on the right track and nearing their goal. Finally grey may be used for other scores, and may serve as an acknowledgement of the students effort. In other embodiments other color schemes may be used.

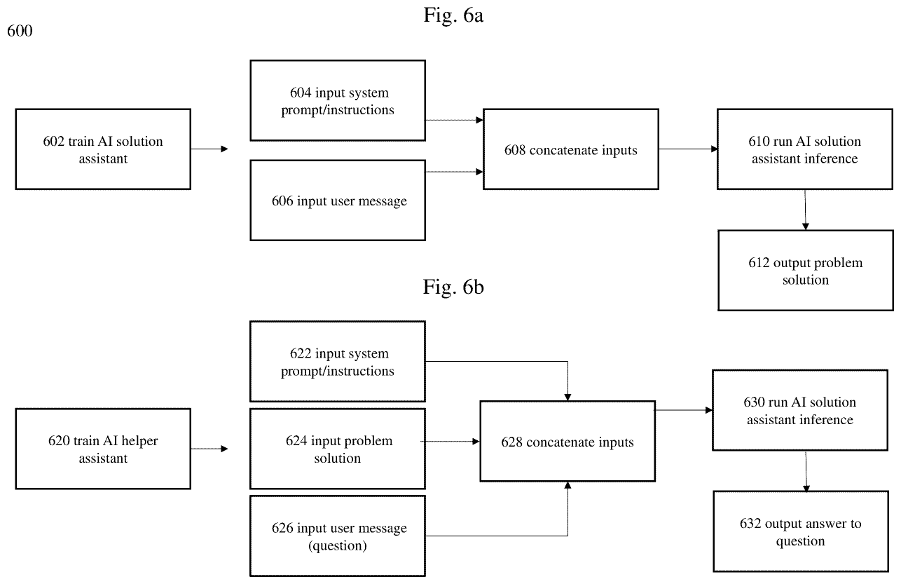

FIGS. 6a-b provide an exemplary illustration of the AI assistant modules 600. Referring generally to FIGS. 6a-b, an AI assistant module may be trained, and a plurality of inputs may be concatenated together and inputted into the trained AI assistant module. Inference may be run on the concatenated inputs and a plurality of outputs may be produced.

FIG. 6a provides an exemplary illustration of an AI solution assistant module according to some embodiments. In a first step 602, an AI solution assistant may be trained using training data. In a next step 608 system prompts or instructions 604 may be concatenated with one or more user messages 606 as input for the AI solution assistant. In a next step 610 AI solution assistant inference may be run on the concatenated input. In a next step 612 a problem solution may be generated as output from the AI solution assistant inference 606.

FIG. 6b provides an exemplary illustration of an AI solution helper module according to some embodiments. In a first step 620, an AI helper assistant may be trained using training data. In a next step 628 system prompts or instructions 622 may be concatenated with problem solutions 624 and one or more user messages or questions 626 as input for the AI helper assistant. In a next step 630 AI helper assistant inference may be run on the concatenated input. In a next step 632 a plurality of answers to the one or more user messages or questions 626 may be generated as output from the AI helper assistant inference 630.

In some embodiments there may be a separate end screen for game D games, which may be called, for example, a practice end screen. For example, there may be a make number practice end screen. The make number practice end screen may show the time allowed and minimum score required for each mental belt or skill level. Depending on the student's score, and other information such as the time allowed, minimum determined score requirements, etc, the font color of the student's displayed final score may change, for example green if the student meets the determined criteria for “passing”, and red if one or more of the criteria are not met. In some embodiments passing may unlock additional games and/or a test game set. In some embodiments after unlocking a test game set, a new GUI element, for example a “let's test” button, which may allow the student to begin an evaluation test.

In an exemplary embodiment exemplary game D may have one or more additional customizations. For example, the numbers shown or read, the speed at which they are shown and read, how many numbers, and the number of digits per a number may all be customized. In an exemplary call out game varied voices may be used, where the voices are determined by the system above, and may be changed through reading the question which may assist in reducing monotony for the student and increasing engagement. In some embodiments the system may determine certain numbers should be avoided, for example if a student frequently misses numbers containing 0, such as 20, 809, 10,003, etc. then those numbers may be avoided. As another example, if a student continuously confuses the numbers 11-19, 11,000-19,000, etc., those numbers may be avoided. As an additional example, if a student frequently mixes up, for example, twelve and twenty, thirteen and thirty, etc., then one or both of the numbers being mixed up may be avoided.

According to one or more embodiments an AI and/or ML assistant may be incorporated into the above systems and methods. The AI assistant may help to provide solutions to a user based on the user's actions during the one or more math games. In some embodiments functionality of the AI assistant may be split between a number of Assistants, for example a Solution Assistant may provide problem solutions to a user based on user inquiries, while a Helper Assistant may answer user questions about an inputted problem solution. It may be understood that in other embodiments these functionalities may be contained within a single Assistant, or in some embodiments additional Assistants may be used.

In some embodiments, the AI assistant is trained on a dataset prior to being deployed. The dataset used for training the AI assistant may include audio, text, image, or tabular data. In order to train the AI assistant, some embodiments may employ training algorithms such as gradient descent, backpropagation, Reinforcement Learning (RL), Reinforcement Learning from Human Feedback (RLHF), fine tuning, or various other training algorithms known to those skilled in the art. Training may continue until a predetermined amount of time has passed, until a certain amount of data has been trained on, or until the model reaches a desired accuracy or performance level on training or testing data.

In some embodiments the AI assistant may respond to user queries provided via, for example, text and/or speech e.g. through a microphone. The AI assistant may likewise provide responses through a plurality of outputs including text and/or speech. In some exemplary embodiments, the AI assistant may include a plurality of preprocessing modules to convert audio data to text data or to otherwise reformat input data, while in other embodiments audio data may be passed directly to the AI assistant without preprocessing.

In other embodiments the AI assistant may receive visual data as input and/or include visual data as output in the form of digital images.

In an exemplary embodiment the AI assistant may take a plurality of additional inputs, including but not limited to the users student history from the student history database, details about an abacus (for example the number of rods in the abacus, the definition of each of the rods), an assigned problem and/or category of problem such as a difficulty level, a language, an answer style, a maximum answer length, etc.

As an example, the AI assistant may be given the inputs and/or determine from one or more databases that the abacus is a 7 rod abacus, the student is about 10 years old, the 4th rod from the left is the reference point for place values, the language is English, the desired answer style is conversational, and the desired maximum answer length is 30 words.

In some embodiments the AI assistant may be given instructions prohibiting the use of complex language or mathematical symbols. In other embodiments, the AI assistant may be instructed affirmatively to only use words that are kind, encouraging, and/or easily understood by children.

In some embodiments the AI assistant may be given an explanation of how to solve math problems on an abacus. This explanation may include algorithms or steps for the AI assistant to use to assist it in efficiently identifying the correct answer. In some embodiments, the explanation may also include instructions for error correction and/or verification techniques that the AI assistant can use to ensure that an answer or method is correct.

In an exemplary embodiment, the plurality of inputs given to the AI assistant may be separated and or tagged with identifying words that indicate to the AI assistant that a specific part of the prompt serves a specific function or represents a specific type of information. For example, a “system” tag may indicate that proceeding text represents instructions from the system, a “problemSolution” tag may indicate that the proceeding text represents a verified correct answer to a given math problem, an “abacusBeads” tag may indicate that the text represents an abacus state in text form, and a “studentQuestion” tag may indicate that the text represents a question from a student. In some embodiments, the type of question and/or question difficulty rating may also be represented to the AI assistant with unique tags.

In some embodiments the AI assistant may be configured to modify parts of the input and/or to modify the abacus to allow it to better solve a given problem.

In some embodiments the plurality of inputs may be concatenated together and given to the AI assistant as a single prompt, while in other embodiments they may be passed separately.

As an example of AI assistant output in some embodiments, the AI assistant may respond to a question such as 2244/22 with a response similar to the following: “We are using an abacus with 7 spots. The spots in the abacus, from left to right, are: the 4 spot, the 3 spot, the 2 spot, the 1 spot, the 0 spot, spot A and spot B. The 1 spot will be the reference point.
1. Start with the initial abacus value: | 0 | 0 | 0 | 2 | 2 | 4 | 4 |
2. The given number is 22, and the working number is 2244.
3. Look at the first two digits of the working number, which is 22. Since 22 is equal to the given number (22), the answer will start at the 3 spot, suggesting a 3-digit answer, and the working number is the first two digits (22).
4. Determine the first digit of the answer: We need a single-digit number that can be multiplied by 22 and can be subtracted from the working number (22).−1*22=22, which can be subtracted from 22. Place the first answer's digit (1) in the 3 spot on the abacus: | 0 | 1 | 0 | 2 | 2 | 4 | 4
5. Subtract 22 from 22. The new working number is 2244−2200=44
6. Update the abacus for the new working number: | 0 | 1 | 0 | 0 | 0 | 4 | 4 |
7. Determine the next digit of the answer.
   Compare the first digit of the new working number, which is 44, to the given number 22. Since 44 is greater than 22, we place the next answer's digit two spots to the left of the new working number, which is the 1 spot.
   Determine the last digit of the answer: We need a single-digit number that, when multiply by 22, can be subtracted from the working number (44).−2*22=44, which can be subtracted from 44. Place this digit in the 1 spot on the abacus: | 0 | 1 | 0 | 2 | 0 | 4 | 4 |
8. Subtract 44 from 44 to get a new working number: 0. Update the abacus to reflect the new working number: | 0 | 1 |0|2 |0|0|0 |.
9. Since the working number is now 0, the division is complete with no remainder. The answer is 102.” The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for math education, comprising:
obtaining situational data from a student device that accesses one or more math games;
filtering a student information database and/or a student history database based on one or more factors determined from the received situational data;
determining one or more math problems based on the filtered student information database and/or student history database;
sending the one or more determined math problems to the student device;
receiving a query from the student device;
inputting the query to an AI assistant module, the AI assistant module comprising a plurality of AI assistants; and
receiving as output a response to the query from the AI assistant module;
sending the response to the student device.

2. The method of claim 1, wherein the one or more math games includes a virtual abacus.

3. The method of claim 1, wherein the plurality of AI assistants includes:
a solution assistant AI module configured to receive the one or more math problems as input and generate a solution as output; and
a helper assistant AI module configured to receive the solution output of the solution assistant AI module and the query as input and generate the response to the query as output.

4. The method of claim 1, wherein the AI assistant module includes a neural network.

5. The method of claim 1, further comprising,
training the AI assistant module on a database prior to use.

6. The method of claim 1, wherein the query is received as audio data from at least one microphone.

7. The method of claim 1, wherein the response is sent to the student device as audio data.

8. The method of claim 2, wherein the AI assistant module receives as input information about the state of the virtual abacus.

9. A system of math education, comprising:
a student device, wherein the student device accesses one or more math games,
a student information database and/or a student history database,
an AI assistant module comprising a plurality of AI assistants, and
a math network communicatively coupled to the student device and comprising a non-transitory memory with instruction stored therein and a processor configured to execute the instructions to perform the steps of:
receiving situational data from the student device,
filtering the student information database and/or a student history database based on one or more factors determined from the received situational data,
determining one or more math problems based on the filtered student information database,
sending the one or more determined math problems to the student device,
receiving a query from the student device,
inputting the query to the AI assistant module,
receiving as output a response to the query from the AI assistant module; and
sending the response to the student device.

10. The system of claim 9, wherein the one or more math games includes a virtual abacus.

11. The system of claim 9, wherein the plurality of AI assistants includes:
a solution assistant AI module configured to receive the one or more math problems as input and generate a solution as output; and
a helper assistant AI module configured to receive the solution output of the solution assistant AI module and the query as input and generate the response to the query as output.

12. The system of claim 9, wherein the AI assistant module includes a neural network.

13. The system of claim 9, further comprising,
training the AI assistant module on a database prior to use.

14. The system of claim 9, wherein the query is received as audio data from at least one microphone.

15. The method of claim 9, wherein the response is sent to the student device as audio data.

16. The system of claim 10, wherein the AI assistant module receives as input information about the state of the virtual abacus.

17. A computer-readable non-transitory medium storing a program causing at least one processor to perform:
obtaining situational data from a student device that accesses one or more math games;
filtering a student information database and/or a student history database based on one or more factors determined from the received situational data;
determining one or more math problems based on the filtered student information database and/or student history database;
sending the one or more determined math problems to the student device;
receiving a query from the student device;
inputting the query to an AI assistant module, the AI assistant module comprising a plurality of AI assistants; and
receiving as output a response to the query from the AI assistant module;
sending the response to the student device.
